(19) United States
(12) Patent Application Publication
(10) Pub. No.: US 2005/0017122 A1
(43) Pub. Date: Jan. 27, 2005

(54) Apparatus and method for forming enlarged base on yarn carrier, and yarn carrier with enlarged base

(75) Inventors: Shawn E. Pederson, Cherryville, NC (US); Jean Francois Ruffet, Gastonia, NC (US)

Correspondence Address: ADAM EVANS, P.A.;(formerly Adams, Schwartz & Evans, P.A.), 2180 TWO WACHOVIA CENTER, CHARLOTTE, NC, 28282, US

(73) Assignee: CONITEX-SONOCO LLC

(21) Appl. No.: 10/625,248

(22) Filed: Jul. 23, 2003

(51) Int. Cl. B65H 75/18; B31C 11/02

(52) U.S. Cl. 242/613.5; 493/296

(57) ABSTRACT

An apparatus for forming an enlarged, reinforced base on a yarn carrier includes a die for positioning around the outer surface of the yarn carrier having an inwardly folded over base portion. The die includes an annular recess for receiving the terminal portion of the yarn carrier therein, and the recess is shaped and sized to correspond to a desired shape of the enlarged base. A clamp holds the yarn carrier as a plunger is inserted into the terminal portion of the yarn carrier, and outwardly urges base of the yarn carrier into the recess of the die, molding the enlarged base on the yarn carrier. In another embodiment of the invention, the plunger and die are rotatable.

### TECHNICAL FIELD AND BACKGROUND OF THE INVENTION

The invention relates to an apparatus and method for producing yarn carriers having a reinforced outwardly extending ridge at one or more ends of the yarn carrier. The invention is directed generally towards yarn carriers that are frusto-conical or cylindrical in shape and which have generally smooth, uninterrupted inner walls. Such yarn carriers are usually referred to as cones or tubes in the textile industry and are made of compressed, impregnated paper fiber. These cones and tubes are typically wound with yarn tails which permit the leading end of yarn on an exhausted cone to be tied to the leading end of yarn on a succeeding full package. The tail is necessary if the transfer from the exhausted to the full package is to take place without dropping needles, which causes a serious defect in the knitted fabric. Consequently, it is an important consideration when winding yarn onto a yarn carrier that such yarn tails do not slip off of the package and become lost.

Prior art plastic yarn carriers have used a raised rim or roughened portion on the outer surface near the base to frictionally engage the yarn tail to prevent its slippage off of the package. Such a configuration is conducive to yarn carriers made from plastic. However, it would be difficult and impractical to form such a raised, roughened portion on the outer surface of a yarn carrier made from paper fiber which would effectively prevent yarn tail slippage.

It is also desirable for the yarn carrier to have reinforced strength at its base edge. Yarn is wound on the yarn carrier while it is positioned on a spinning machine. Typically, the yarn carrier is then removed from the spinning machine and transported a remote distance to a knitting operation in which the yarn carrier is placed on a creel. During transport from the spinning machine to the creel, it is common for the yarn carrier to be dropped on its base and to undergo other kinds of accidents incidental to the shipping process. Damage to the base of the yarn carrier will prevent the yarn from coming off of the base properly when the knitter attempts unwind the yarn carrier. Therefore, it is desirable for the yarn carrier to have a reinforced base.

Prior art yarn carriers exist in which the base edge of the carrier is rolled inwardly to on the inner surface of the yarn carrier. While the rolled over portion stabilizes the carrier, and adds radial and axial strength, it is also desirable, as noted above, for there to be an outwardly extending ridge at the base end to prevent yarn tail slippage. As such, there is a need for an apparatus and method for efficiently forming a paper yarn carrier having a reinforced outwardly extending base.

### SUMMARY OF THE INVENTION

Therefore it is an object of the present invention to provide an apparatus for producing a yarn carrier having a reinforced enlarged base.

It is another object of the present invention to provide a method for molding a yarn carrier with a having a reinforced enlarged base.

These and other objects of the present invention are achieved by providing an apparatus for forming an enlarged base on a yarn carrier having a clamp for holding a paper yarn carrier having walls defining an inner surface and an outer surface with a terminal portion located at an end thereof, and a die for being positioned around the outer surface of the yarn carrier defining the terminal portion. The die includes an annular recess for receiving the terminal portion of the yarn carrier therein, and the recess is shaped and sized to correspond to a desired shape of the enlarged base. A plunger is inserted into the terminal portion of the yarn carrier, and outwardly urges base of the yarn carrier into the recess of the die, molding the enlarged base on the yarn carrier.

According to a preferred embodiment of the invention, the terminal portion of the yarn carrier is folded inwardly to form a rolled over portion on the inner surface, the rolled over portion initially defining an inner diameter and an outer diameter each no greater than a diameter of a remaining portion of the yarn carrier. Molding the terminal portion comprises enlarging the outer diameter of the rolled over portion to a diameter greater than the remaining portion of the yarn carrier and forming a reinforced enlarged base on the yarn carrier.

According to another preferred embodiment of the invention, molding the terminal portion includes enlarging the inner diameter of the rolled over portion to a diameter greater than the remaining portion of the yarn carrier and forming the reinforced enlarged base on the yarn carrier.

According to another preferred embodiment of the invention, the plunger includes a front end having a diameter less than the terminal portion of the yarn carrier and graduating to a rear end having a diameter greater than the terminal portion of the yarn carrier. As such, the plunger frictionally engages the inner surface of the yarn carrier at the terminal portion as the plunger is inserted into the yarn carrier and urges the terminal portion outwardly into the recess of the die to mold the enlarged base on the yarn carrier.

According to another preferred embodiment of the invention, the plunger is rotatable for exerting force against the inner surface of the yarn carrier and creating friction heat facilitating the molding of the yarn carrier.

According to another preferred embodiment of the invention, the die includes two arcuate die segments positioned in complimentary fashion around the outer surface proximate the terminal portion of the yarn carrier. The die segments are movable in relation to the yarn carrier.

According to yet another preferred embodiment of the invention, each of The die segments are driven by an air cylinder.

According to yet another preferred embodiment of the invention, the apparatus for forming an enlarged base on a yarn carrier includes a rotatable plunger for inserting into a first end of a hollow yarn carrier having walls defining an outer surface and inner surface. The plunger includes a front end having a diameter less than the first end of the yarn carrier and graduates to a rear end having a diameter greater than the first end of the yarn carrier. As such, the plunger frictionally engages the inner surface at a terminal portion of the yarn carrier. A die is positioned around the outer surface proximate the first end of the yarn carrier. The die defines an annular recess for receiving the terminal portion of the yarn carrier therein, and the recess is shaped and sized to correspond to a desired shape of the enlarged base. The yarn carrier and the plunger are rotated on a longitudinal axis, and the plunger forces the terminal portion of the yarn carrier into the recess of the die to mold the enlarged base on the yarn carrier.

According to yet another preferred embodiment of the invention, the terminal portion of the yarn carrier is folded inwardly on the inner surface to form a rolled over portion defining an inner diameter and an outer diameter each less than a diameter of a remaining portion of the yarn carrier. Molding the terminal portion includes enlarging the outer diameter of the rolled over portion to a diameter greater than the remaining portion of the yarn carrier and forming a reinforced enlarged base on the yarn carrier.

According to yet another preferred embodiment of the invention, molding the terminal portion includes enlarging the inner diameter of the rolled over portion to a diameter greater than the remaining portion of the yarn carrier and forming the reinforced enlarged base on the yarn carrier.

According to yet another preferred embodiment of the invention, a motor is connected to the rotatable plunger for driving the plunger and rotating the yarn carrier.

According to yet another preferred embodiment of the invention, a motor is connected to a rotatable mandrel for driving the mandrel. The mandrel is inserted into a second end of the yarn carrier, and rotates the yarn carrier and the plunger.

According to yet another preferred embodiment of the invention, the die includes two arcuate die segments positioned in complimentary fashion around the outer surface proximate the first end of the yarn carrier. The die segments are rotatable on an axis parallel to the longitudinal axis of the yarn carrier.

According to yet another preferred embodiment of the invention, the die segments are driven by an air cylinder and movable in relation to the yarn carrier.

According a preferred method for forming an enlarged base on a yarn carrier according to the invention, includes providing a paper yarn carrier defining an inner surface and an outer surface on opposite sides thereof, and at least one end of the yarn carrier folded inwardly to form a rolled over portion on the inner surface at a terminal portion of the yarn carrier. A chuck is provided having a recess therein shaped to receive the terminal portion of the yarn carrier and extend the terminal portion of the yarn carrier outwardly upon rotating the chuck. The terminal portion of the yarn carrier is positioned in to the recess of the chuck, and the chuck is rotated. The diameter of the terminal portion of the yarn carrier wall is extended outwardly and molded to form an enlarged base on the yarn carrier.

Another preferred method for making a yarn carrier according to the invention includes the step of maintaining the yarn carrier in a stable position as the chuck rotates by frictionally engaging the yarn carrier with a clamp.

Yet another preferred method for making a yarn carrier according to the invention includes the step of providing a paper yarn carrier that is frusto-conical or cylindrical, and the yarn carrier defines an inner surface and an outer surface on opposite sides thereof, and at least one end of the yarn carrier is folded inwardly to form a rolled over portion on the inner surface at a terminal portion of the yarn carrier.

Yet another preferred method for making a yarn carrier according to the invention includes providing a paper yarn carrier defining an inner surface and an outer surface on opposite sides thereof, and at least one end of the yarn carrier is folded inwardly to form a rolled over portion on the inner surface at a terminal portion of the yarn carrier. A die is positioned against the outer surface at the terminal portion of the yarn carrier. The die defines a recess for receiving the terminal portion of the yarn carrier. The recess is shaped and sized to correspond to a desired shape and diameter of the enlarged base. Finally, a molding mechanism is positioned within the yarn carrier at the terminal portion for inserting the terminal portion into the recess of the die to mold the enlarged base on the yarn carrier.

Yet another preferred method for making a yarn carrier according to the invention includes the step of inserting a plunger with a front end having a diameter less than the terminal portion of the yarn carrier and graduating to a rear end having a diameter greater than the terminal portion of the yarn carrier. The plunger frictionally engages the inner surface at the terminal portion and urges the terminal portion outwardly into the recess of the die to form the enlarged base on the yarn carrier.

Yet another preferred method for making a yarn carrier according to the invention includes positioning a plunger rotating on a longitudinal axis of the yarn carrier and comprising a front end having a diameter less than the terminal portion of the yarn carrier and graduating to a rear end having a diameter greater than the terminal portion of the yarn carrier. The rotating plunger frictionally engages the inner surface at the terminal portion and urges the terminal portion outwardly into the recess of the die to mold the enlarged base on the yarn carrier.

Yet another preferred method for making a yarn carrier according to the invention includes the step of supporting the yarn carrier in a stable position with a clamp.

Yet another preferred method for making a yarn carrier according to the invention includes the step of providing a paper yarn carrier that is frusto-conical or cylindrical and defining an inner surface and an outer surface on opposite sides thereof. At least one end of the yarn carrier is folded inwardly to form a rolled over portion on the inner surface at a terminal portion of the yarn carrier.

Yet another preferred method for making a yarn carrier according to the invention includes providing a paper yarn carrier defining an inner surface and an outer surface on opposite sides thereof, and at least one end of the yarn carrier is folded inwardly to form a rolled over portion on the inner surface at a terminal portion of the yarn carrier. A die is positioned against the outer surface at the terminal portion of the yarn carrier. The die defines a recess for receiving the terminal portion of the yarn carrier, and the recess is shaped and sized to correspond to a desired shape and diameter of the enlarged base. A rotatable plunger is positioned within the yarn carrier at the terminal portion. The plunger includes a front end having a diameter less than the terminal portion of the yarn carrier and graduates to a rear end having a diameter greater than the terminal portion of the yarn carrier so that the plunger frictionally engages the inner surface at the terminal portion as the plunger is inserted into the yarn carrier. The rotatable plunger is inserted into the yarn carrier, and rotated to urge the terminal portion of the yarn carrier outwardly into the recess of the die to mold the enlarged base on the yarn carrier.

Yet another preferred method for making a yarn carrier according to the invention includes providing two arcuate complimentary die segments moveable in relation to the yarn carrier and pivotable on an axis parallel to a longitudinal axis of the yarn carrier, and positioning the die segments against the outer surface of the terminal portion.

Yet another preferred method for making a yarn carrier according to the invention includes positioning a rotatable mandrel within the yarn carrier at an end opposite to the plunger, and rotating the mandrel.

Yet another preferred method for making a yarn carrier according to the invention includes providing a paper yarn carrier defining an inner surface and an outer surface on opposite sides thereof, and at least one end of the yarn carrier is folded inwardly to form a rolled over portion on the inner surface at a terminal portion of the yarn carrier. A chuck is provided having a recess shaped to receive the terminal portion of the yarn carrier and extend the terminal portion of the yarn carrier outwardly upon rotating the chuck. The terminal portion of the yarn carrier is forced into the recess of the chuck, and the chuck is rotated. The diameter of the terminal portion of the yarn carrier wall is extended outwardly and molded to form an enlarged base on the yarn carrier.

Yet another preferred method for making a yarn carrier according to the invention includes providing a paper yarn carrier defining an inner surface and an outer surface on opposite sides thereof, and at least one end of the yarn carrier is folded inwardly to form a rolled over portion on the inner surface at a terminal portion of the yarn carrier. A die is positioned against the outer surface at the terminal portion of the yarn carrier. The die defines a recess for receiving the terminal portion of the yarn carrier, and the recess is shaped and sized to correspond to a desired shape and diameter of the enlarged base. A molding mechanism is positioned within the yarn carrier at the terminal portion for inserting the terminal portion into the recess of the die to mold the enlarged base on the yarn carrier.

According to yet another preferred embodiment of the invention, a yarn carrier having an enlarged base formed by a process that includes providing a paper yarn carrier defining an inner surface and an outer surface on opposite sides thereof. At least one end of the yarn carrier is folded inwardly to form a rolled over portion on the inner surface at a terminal portion of the yarn carrier. A die is positioned against the outer surface at the terminal portion of the yarn carrier. The die defines a recess for receiving the terminal portion of the yarn carrier, and the recess is shaped and sized to correspond to a desired shape and diameter of the enlarged base. A rotatable plunger is positioned within the yarn carrier at the terminal portion. The plunger includes a front end having a diameter less than the terminal portion of the yarn carrier and graduates to a rear end having a diameter greater than the terminal portion of the yarn carrier. The plunger frictionally engages the inner surface at the terminal portion as the plunger is inserted into the yarn carrier. The terminal portion of the yarn carrier is urged outwardly into the recess of the die to mold the enlarged base on the yarn carrier.

### BRIEF DESCRIPTION OF THE DRAWINGS

Some of the objects of the invention have been set forth above. Other objects and advantages of the invention will appear as the invention proceeds when taken in conjunction with the following drawings, in which:

FIG. 1A is a cross sectional diagrammatic view of a molding apparatus according to a preferred embodiment of the invention, shown in use with a frusto-conical yarn carrier;

FIG. 1B is another cross sectional diagrammatic view of the molding apparatus shown in FIG. 1A;

FIG. 1C is another cross sectional diagrammatic view of the molding apparatus shown in FIG. 1A;

FIG. 2A is another cross sectional diagrammatic view of the molding apparatus shown in FIG. 1A, shown in use with a cylindrical yarn carrier;

FIG. 2B is another cross sectional diagrammatic view of the molding apparatus shown in FIG. 1A;

FIG. 2C is another cross sectional diagrammatic view of the molding apparatus shown in FIG. 1A;

FIG. 3A is a cross sectional diagrammatic view of a molding apparatus according to another preferred embodiment of the invention, shown in use with a frusto-conical yarn carrier;

FIG. 3B is another cross sectional diagrammatic view of the molding apparatus shown in FIG. 3A;

FIG. 3C is another cross sectional diagrammatic view of the molding apparatus shown in FIG. 3A;

FIG. 4A is another cross sectional diagrammatic view of the molding apparatus shown in FIG. 3A, shown in use with a cylindrical yarn carrier;

FIG. 4B is another cross sectional diagrammatic view of the molding apparatus shown in FIG. 1A;

FIG. 4C is another cross sectional diagrammatic view of the molding apparatus shown in FIG. 1A;

FIG. 5A is a cross sectional diagrammatic view of a molding apparatus according to yet another preferred embodiment of the invention;

FIG. 5B is another cross sectional diagrammatic view of the molding apparatus shown in FIG. 5A;

FIG. 5C is another cross sectional diagrammatic view of the molding apparatus shown in FIG. 5A;

FIG. 6A is a cross sectional diagrammatic view illustrating a preferred method for forming a yarn carrier according to the invention, with a frusto-conical yarn carrier;

FIG. 6B is another cross sectional diagrammatic view illustrating the method shown in FIG. 6A;

FIG. 6C is another cross sectional diagrammatic view illustrating the method shown in FIG. 6A;

FIG. 7A is another cross sectional diagrammatic view illustrating the method of FIG. 6A, with a cylindrical yarn carrier;

FIG. 7B is another cross sectional diagrammatic view of the method of FIG. 6A; and

FIG. 7C is another cross sectional diagrammatic view of the method of FIG. 6A.

### DETAILED DESCRIPTION OF THE PREFERRED EMBODIMENTS AND BEST MODE

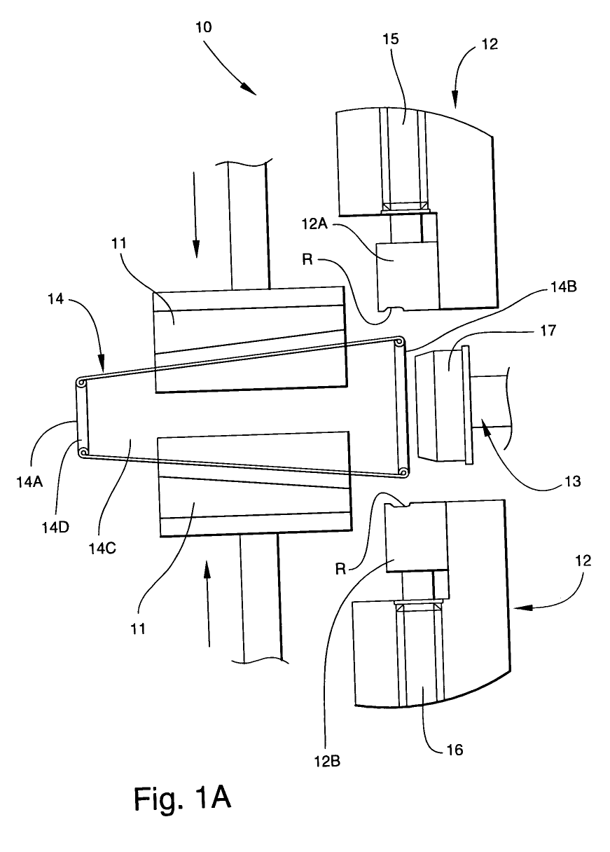

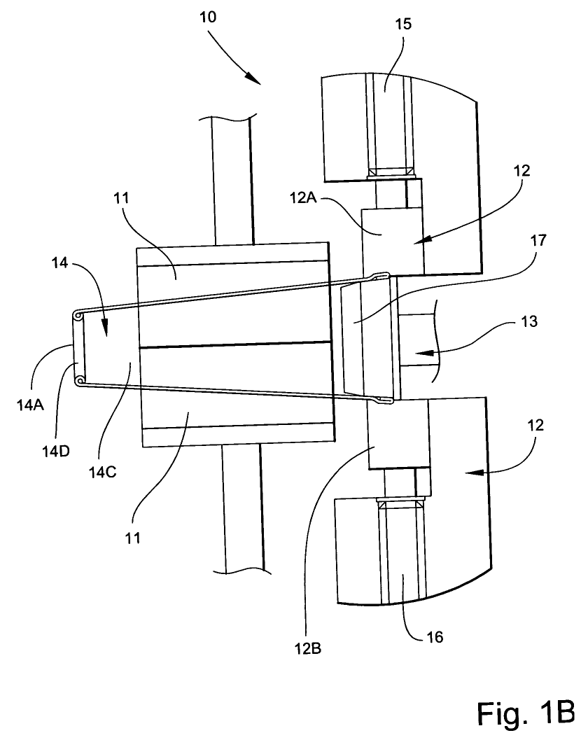

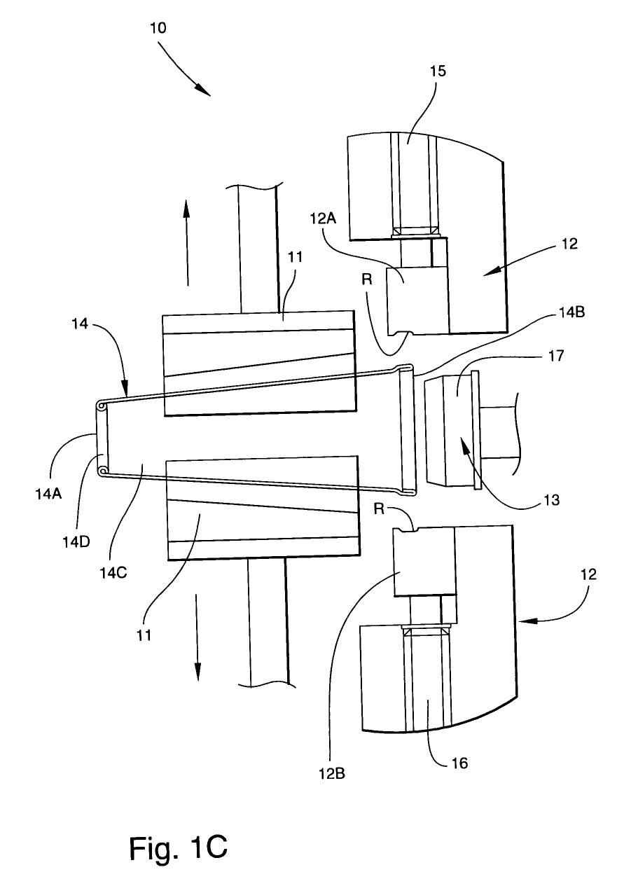

An apparatus for making a yarn carrier according to a preferred embodiment of the invention is illustrated in FIGS. 1A-1C and shown generally at reference numeral 10. The apparatus 10 comprises a clamp 11, a die 12, and a plunger 13. The apparatus 10 molds a paper yarn carrier 14 having a reinforced outwardly extending terminal portion.

According to one embodiment of the invention, the yarn carrier 14 is frusto-conical, and comprises a nose 14A, a base 14B, and walls defining an inner surface 14C and an outersurface 14D. Preferably, the edge of the nose 14A and the edge of the base 14B are rolled inwardly onto the inner surface 14C of the yarn carrier 14 by a conventional process such as spin molding. As such, the base 14B has an inner diameter defined by the inner most edge of the rolled over portion, and an outer diameter defined by the outermost edge of the rolled over portion. The clamp 11 grips the outer surface 14D of the yarn carrier and holds the yarn carrier 14 in place.

The die 12 comprises two arcuate segments 12A, 12B positioned in complimentary fashion around the base 14B of the yarn carrier 14. The die segments 12A, 12B are driven by air cylinders 15, 16, respectively, and are movable in relation to the yarn carrier 14 and each other. Each die segment 12A, 12B defines a recess R that is sized and shaped to correspond to a desired shape of the base 14B. When positioned in a molding position, shown in FIG. 1B, the segments 12A, 12B are positioned adjacent the base 14B of the yarn carrier 14, and engage each other to form a continuous annular recess R around the base 14B. The die segments 12A, 12B form a continuous annular structure having a diameter slightly larger than the base 14B.

The plunger 13 includes a head 17 that is cylindrical in shape with a front end having a diameter slightly smaller than the base 14B of the yarn carrier 14. This facilitates introduction of the plunger head 17 into the yarn carrier 14. The diameter of the head 17 gradually increases from the front end to the rear end, which has a diameter greater than the base 14B.

The die segments 12A, 12B are moved into the molding position as shown in FIG. 1B. The plunger 13 is inserted into the yarn carrier 14 through the base end 14B. As the plunger 13 is moved into the yarn carrier 14, the plunger head 17 engages the inner surface 14C of the yarn carrier 14. The plunger 13 moves forward, and the graduating diameter of the plunger head 17 forces the base 14B of the yarn carrier outwardly into the recess R of the die 12. The rolled over portion on the inner surface 14C of the yarn carrier 14 is flattened and the base 14B is extended outwardly into the die 12 to extrude a reinforced enlarged base 14B. The plunger 13 is then removed from the yarn carrier 14, and the die segments 12A, 12B are moved away from the yarn carrier 14, as shown in FIG. 1C.

The outer diameter of the base 14B extends outwardly from the rest of the yarn carrier 14 to create a slight ridge, for preventing yarn tail slippage. The inner diameter of the base 14B is shown in FIG. 1C to be in line with the frusto-conical shape of the rest of the yarn carrier 14, however, alternatively, the yarn carrier 14 can be formed such that the inner diameter of the base 14B extends outwardly from the rest of the yarn carrier 14. In yet another alternative embodiment, the inner diameter of the base 14B can be made to extend inwardly from the rest of the yarn carrier 14.

In an alternative embodiment, the plunger 13 is rotatable against the inner surface 14C of the yarn carrier 14 to enhance the molding process. In this alternative embodiment, the plunger 13 is preferably driven by an motor connected to the plunger 13.

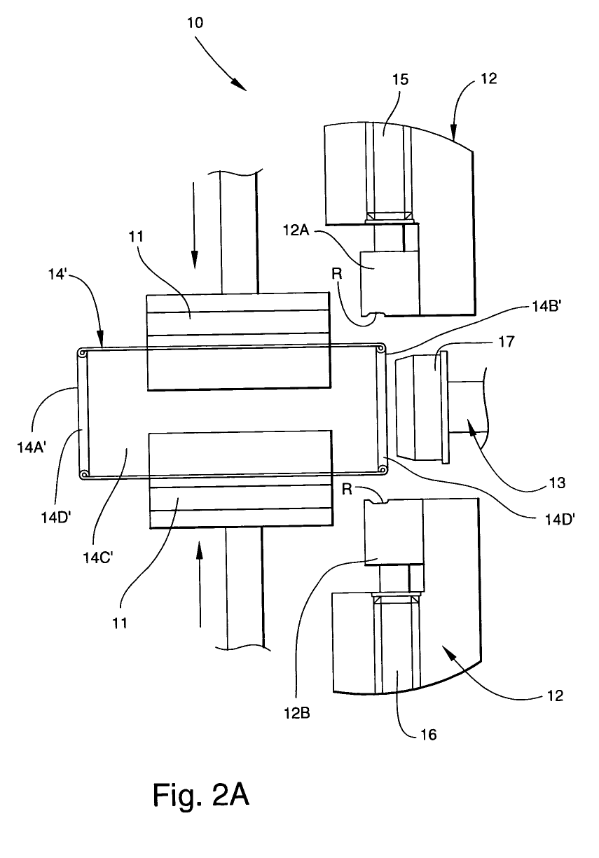

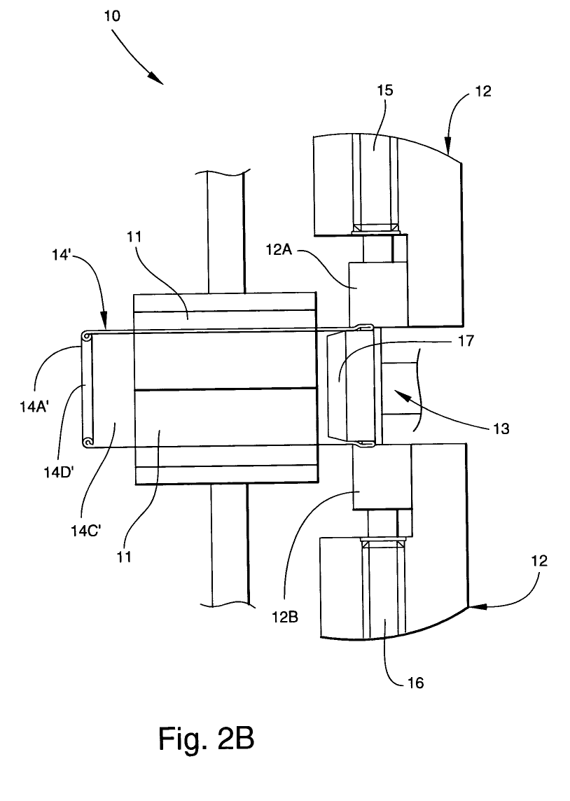

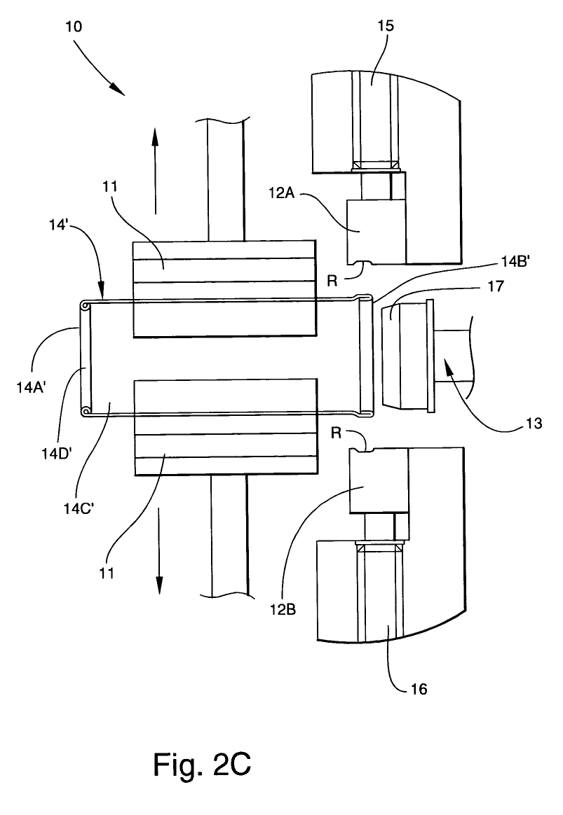

FIGS. 2A-2C depict the apparatus 10 in the same process as that described above in reference to FIGS. 1A-1C, except that FIGS. 2A-2C show the apparatus 10 being used in conjunction with a cylindrical yarn carrier 14′. As such, FIGS. 2A-2C will not be described in further detail.

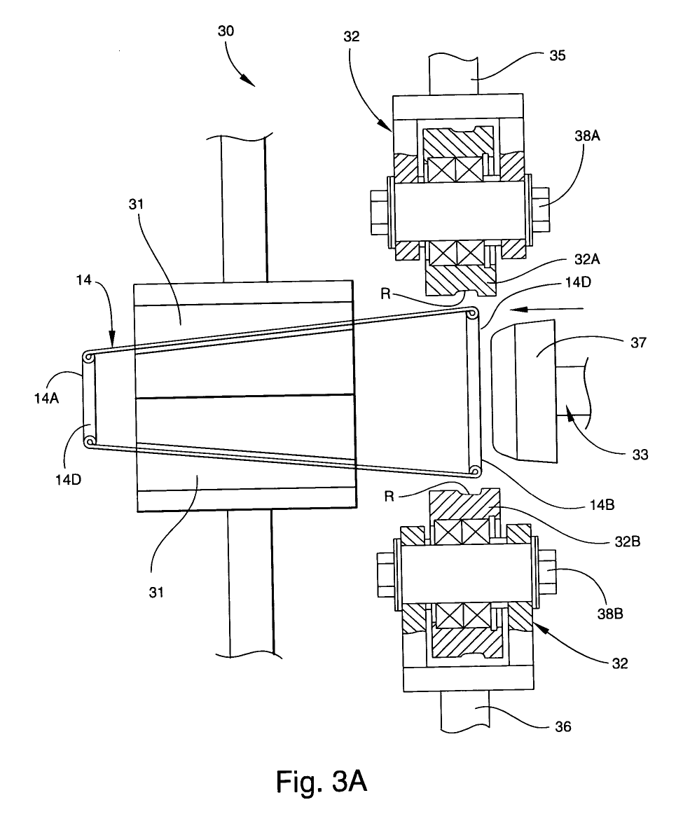

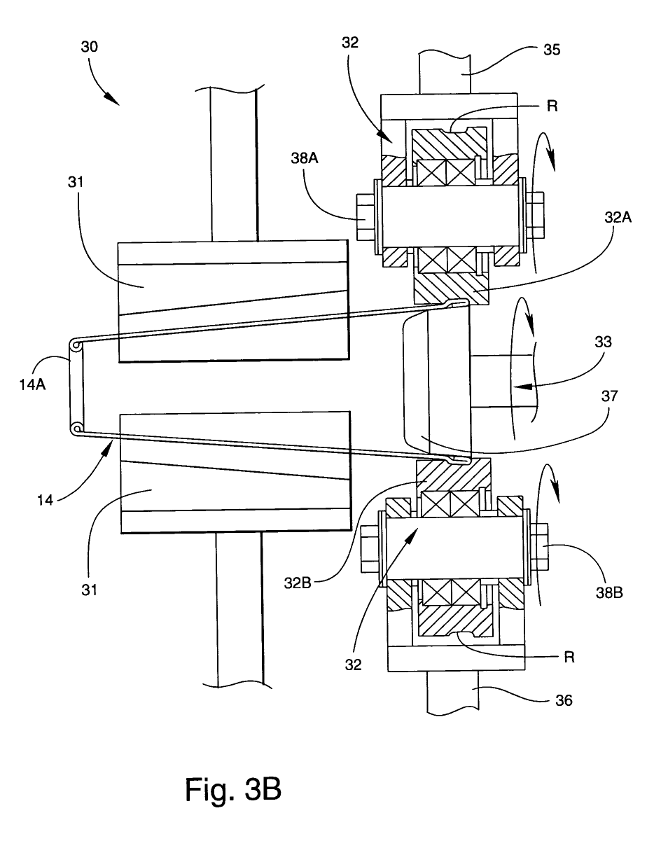

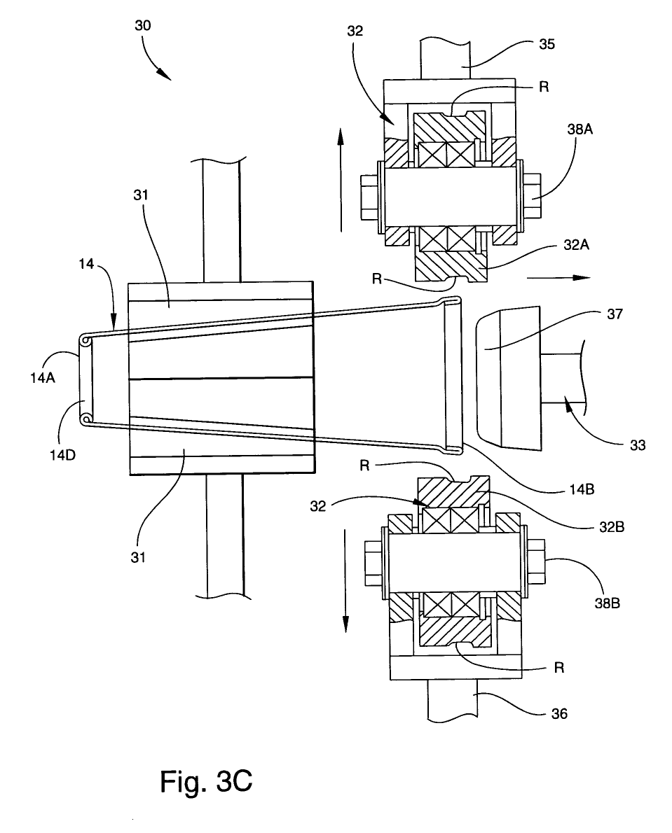

Another preferred embodiment of an apparatus for making a yarn carrier according to the invention is illustrated in FIGS. 3A-3C and shown generally at reference numeral 30. The apparatus 30 comprises a clamp 31, a die 32, and a plunger 33. The apparatus 30 molds a paper yarn carrier 14 having a reinforced outwardly extending terminal portion. The yarn carrier 14 is the same carrier as described above, and therefore will not be described in further detail.

The clamp 31 grips the outer surface 14D of the yarn carrier and holds the yarn carrier 14 in place. The die 32 comprises two arcuate segments 32A, 32B positioned in complimentary fashion around the base 14B of the yarn carrier 34. The die segments 32A, 32B are driven by air cylinders 35, 36, respectively, and are movable in relation to the yarn carrier 34 and each other. In addition, the die segments 32A, 32B are connected to bearings 38A, 38B, respectively, that allow the die segments 32A, 32B to spin on an axis parallel to the longitudinal axis of the yarn carrier 14, as shown in FIG. 3B. Each die segment 32A, 32B defines a recess R that is sized and shaped to correspond to a desired shape of the base 14B. When positioned in the molding position, shown in FIG. 3B, the segments 32A, 32B are positioned adjacent the base 14B of the yarn carrier 14, and engage each other to form a continuous annular recess R around the base 14B. The die segments 32A, 32B form a complete circle having a diameter slightly larger than the base 14B.

The plunger 33 includes a head 37 that is cylindrical in shape and has a front end having a diameter slightly smaller than the base 14B of the yarn carrier 14. The diameter of the head 37 gradually increases from the front end to the rear end, which has a diameter greater than the base 34B. The plunger 33 is rotatable along the longitudinal axis of the yarn carrier 14, as shown in FIG. 3B, and is preferably driven by a motor connected to the plunger 33.

The die segments 32A, 32B are moved into the molding position as shown in FIG. 3B. The plunger 33 is inserted into the yarn carrier 14 through the base end 14B. As the plunger 33 is moved into the yarn carrier 14, the graduated diameter of the plunger head 37 engages the inner surface 14C of the yarn carrier 14. The clamp 31 is removed from the yarn carrier 14, and the yarn carrier 14 is supported by the plunger 33. As shown in FIG. 3B, the plunger 33 rotates the yarn carrier 14 and the plunger head 37 forces the base 14B of the yarn carrier 14 outwardly into the recess R of the die segments 12A, 12B. The die segments 32A, 32B are rotated by their engagement with the rotating yarn carrier 14. The rolled over portion on the inner surface 14C of the yarn carrier 14 is flattened and the base 14B is extended outwardly into the die 32 to mold a reinforced enlarged base 14B. As shown in FIG. 3C, the clamp 31 re-engages the yarn carrier 14, the plunger 33 is removed from the yarn carrier 14, and the die segments 32A, 32B move away from the yarn carrier 14.

The outer diameter of the base 14B extends outwardly from the rest of the yarn carrier 14 to create a slight ridge. The inner diameter of the base 14B is shown in FIG. 1C to be in line with the frusto-conical shape of the rest of the yarn carrier 14, however, alternatively, the yarn carrier 14 can be formed such that the inner diameter of the base 14B extends outwardly from the rest of the yarn carrier 14. In yet another alternative embodiment, the inner diameter of the base 14B can be made to extend inwardly from the rest of the yarn carrier 14.

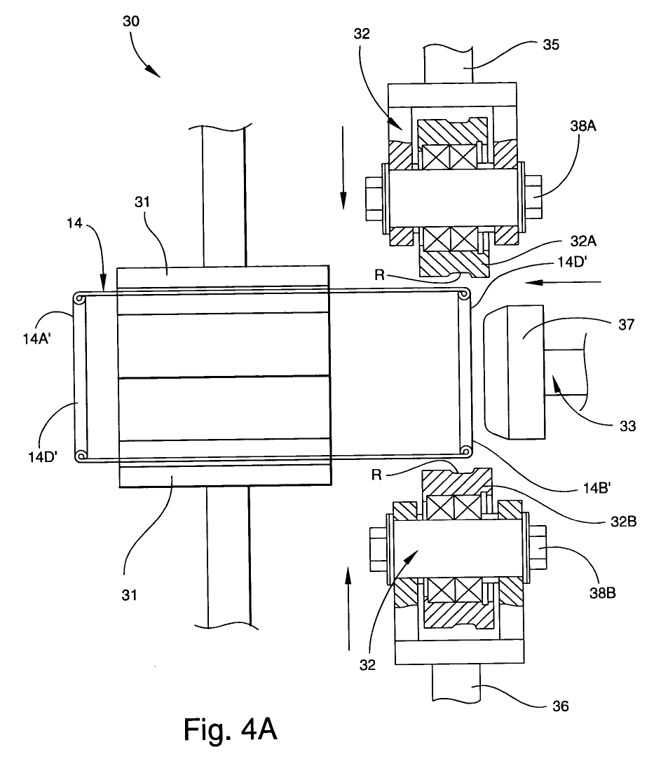

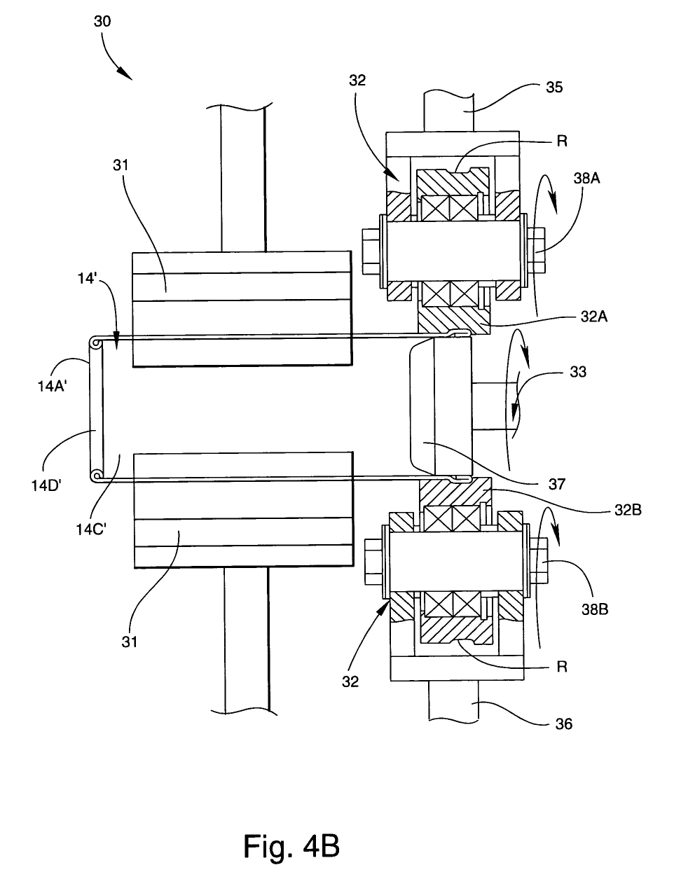

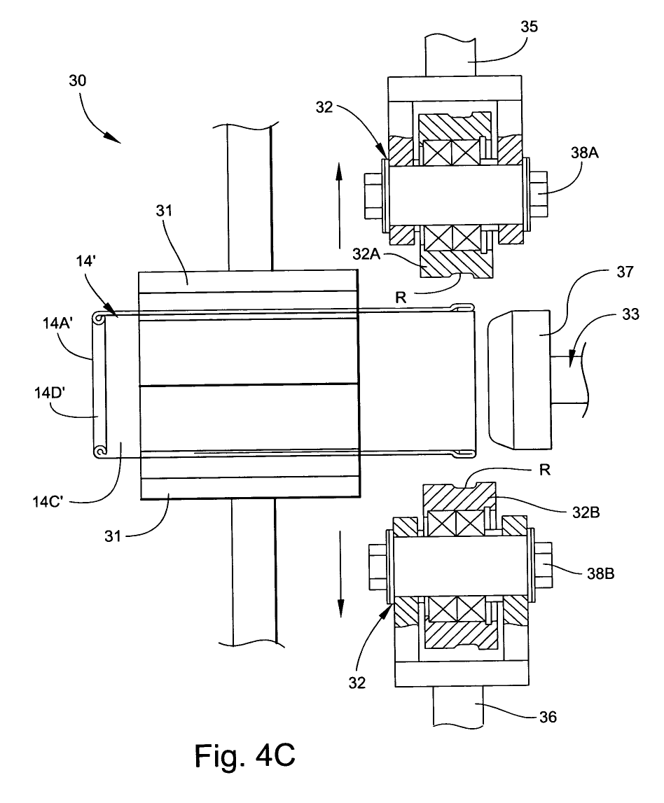

FIGS. 4A-4C depict the apparatus 30 in the same process as that described above in reference to FIGS. 3A-3C, except that FIGS. 4A-4C show the apparatus 30 being used in conjunction with the cylindrical yarn carrier 14′. Therefore, FIGS. 4A-4C will not be described in further detail.

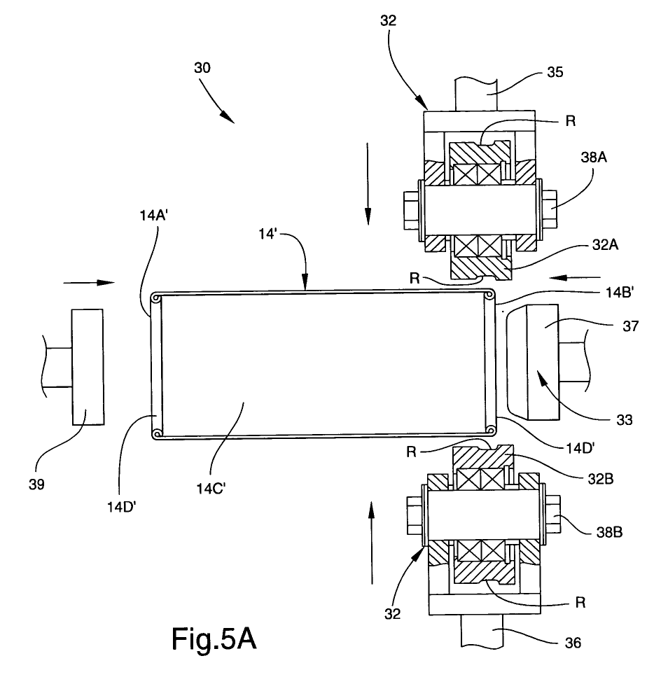

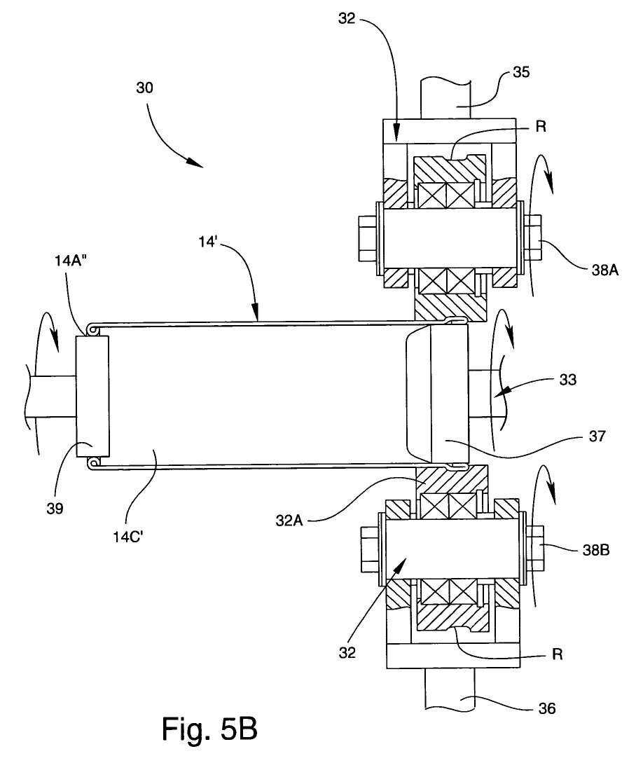

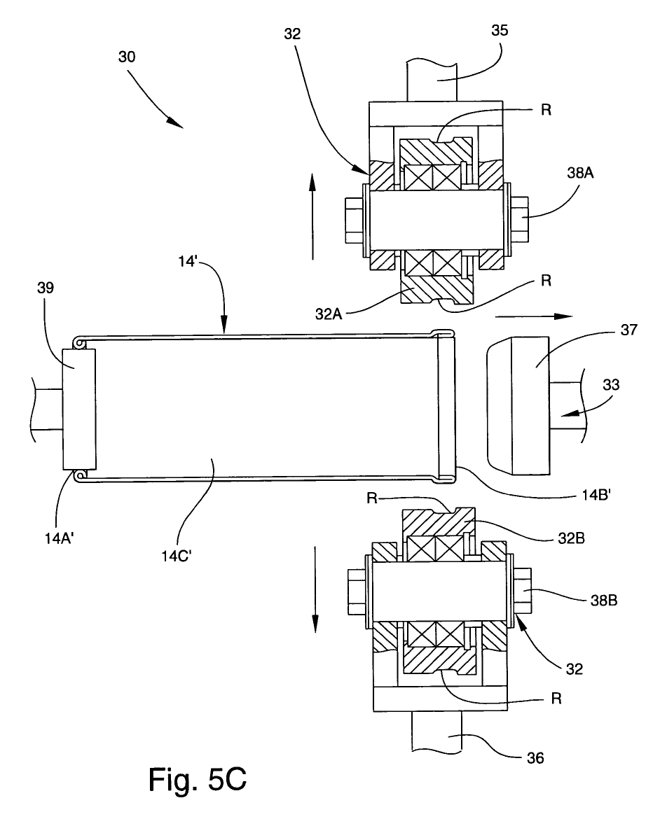

FIGS. 5A-5C depict the apparatus 30 described above, with the addition of a rotatable mandrel 39 that is positioned in the nose end 14A′ of the yarn carrier 14′, as shown in FIG. 5B. The mandrel 39 is driven by a motor connected to the mandrel 39, and rotates the yarn carrier 14′ about its longitudinal axis. The mandrel 39 eliminates the need for the plunger 33 to drive the rotation of the yarn carrier 14′. In addition, the mandrel 39 supports the yarn carrier 14′, eliminating the need for the clamp 31. Although FIGS. 5A-5C depict the apparatus 30 being used on the cylindrical yarn carrier 14′, this embodiment can also be used in conjunction with the frusto-conical yarn carrier 14.

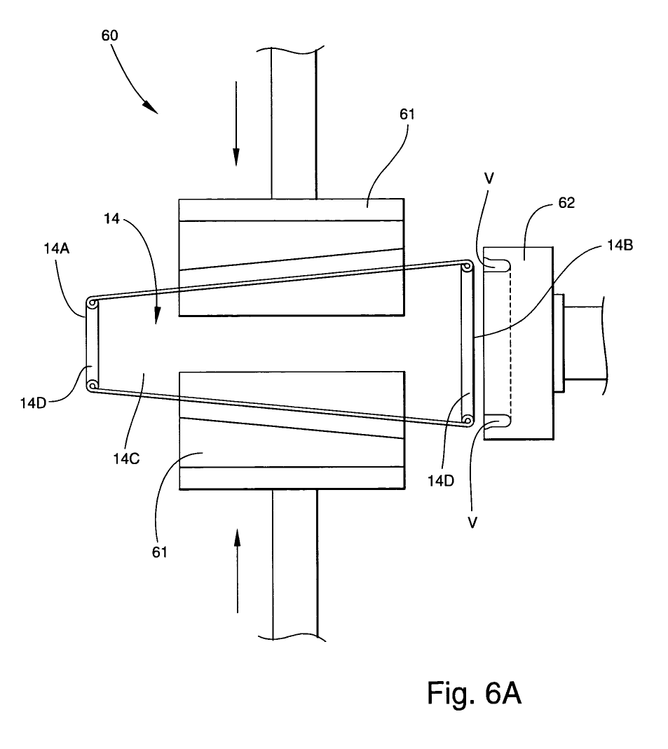

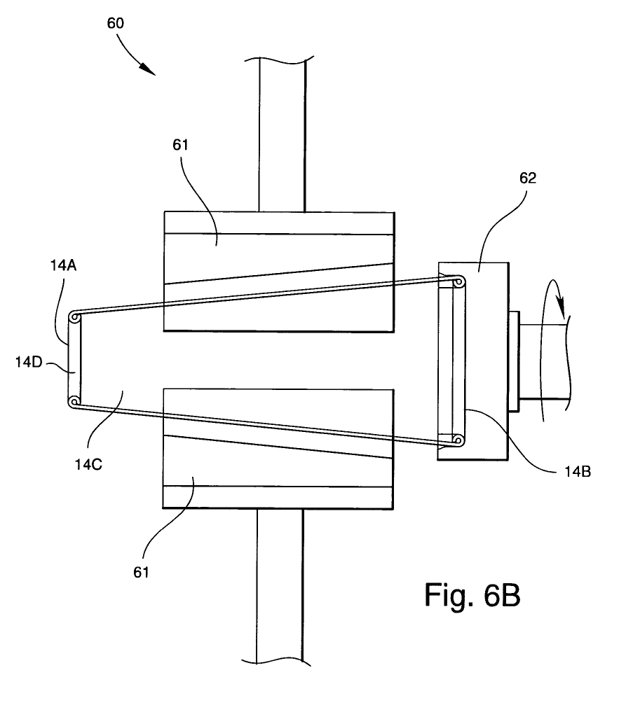

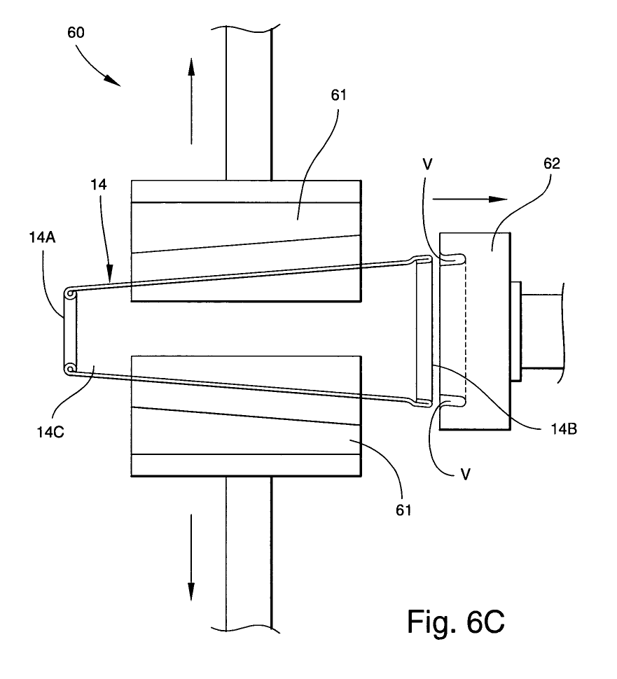

A preferred embodiment of a method for molding a yarn carrier having a reinforced outwardly extending terminal portion is illustrated in FIGS. 6A-6C. The method utilizes a conventional spin molding apparatus shown generally at reference numeral 60. As shown in FIG. 6A, a rotating chuck 62 is provided having a void V for receiving the base end 14B of the yarn carrier 14. The void V is sized and shaped to correspond to the desired shape of the base 14B.

As shown in FIG. 6A, the yarn carrier is supported by a clamp 61. The base end 14B of the yarn carrier 14 is positioned in the void V of the chuck 62, as shown in FIG. 6B. Preferably, the chuck 62 is allowed to rotate for several minutes prior to introducing the yarn carrier 14 in order to generate the optimum amount of heat for the process. The chuck 62 rotates, forcing the base end 14B outward and flattening the rolled over portion on the inner surface 14C of the yarn carrier 14 to produce a reinforced enlarged base 14B. Finally, the yarn carrier 14 is removed from the chuck 62. The outer diameter of the base 14B extends outwardly from the rest of the yarn carrier 14 to create a slight ridge. The inner diameter of the base 14B is shown in FIG. 6C to be in line with the frusto-conical shape of the rest of the yarn carrier 14, however, alternatively, the yarn carrier 14 can be formed such that the inner diameter of the base 14B extends outwardly from the rest of the yarn carrier 14. In yet another alternative embodiment, the inner diameter of the base 14B can be made to extend inwardly from the rest of the yarn carrier 14.

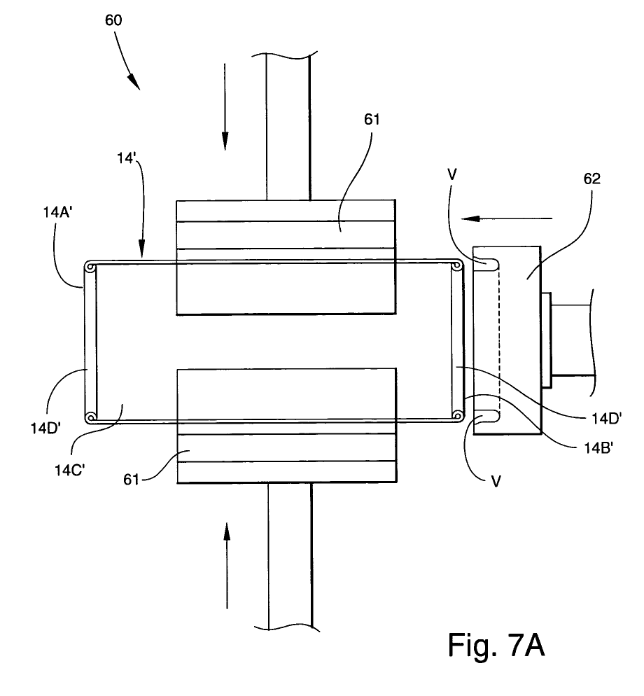

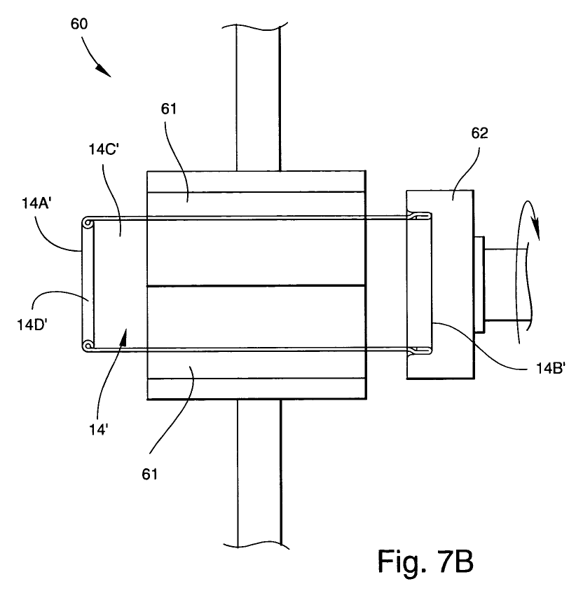

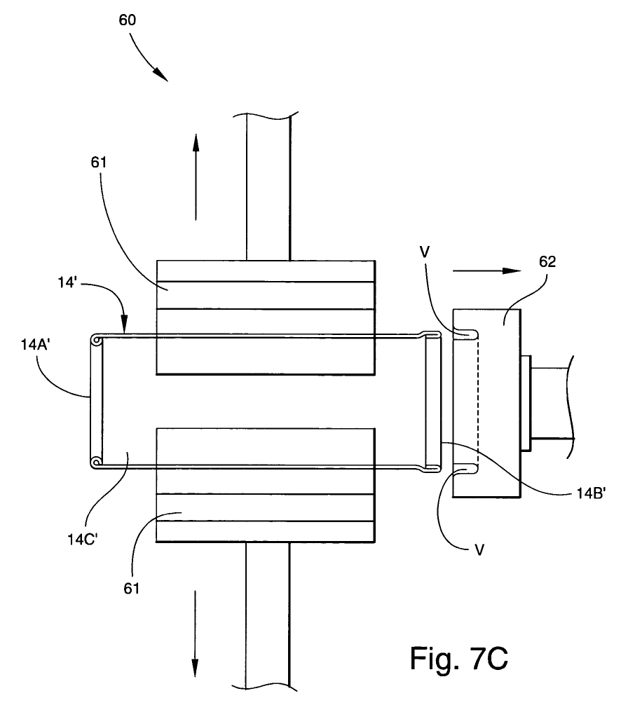

FIGS. 7A-7C depict the same process as that described above referencing FIGS. 6A-6C, except that FIGS. 7A-7C show the process using the cylindrical yarn carrier 14′. Therefore, FIGS. 7A-7C will not be described in further detail.

An apparatus and method for making a yarn carrier with an enlarged base is disclosed above. Various embodiments of the invention can be made without departing from its scope. Furthermore, the foregoing description of the preferred embodiments of the invention and the best mode for practicing the invention are provided for the purpose of illustration only and not for the purpose of limitation—the invention being defined by the following claims.

1. An apparatus for forming an enlarged base on a yarn carrier comprising:
(a) a clamp for holding a paper yarn carrier having walls defining an inner surface and an outer surface with a terminal portion located at an end thereof;
(b) a die for being positioned around the outer surface of the yarn carrier defining the terminal portion, said die comprising an annular recess for receiving the terminal portion of the yarn carrier therein, the recess shaped and sized to correspond to a desired shape of the enlarged base; and
(c) molding means for inserting the terminal portion of the yarn carrier outwardly into the recess of said die and molding the enlarged base on the yarn carrier.

2. An apparatus according to claim 1, wherein prior to molding the yarn carrier the terminal portion of the yarn carrier is folded inwardly to form a rolled over portion on the inner surface, the rolled over portion initially defining an inner diameter and an outer diameter each no greater than a diameter of a remaining portion of the yarn carrier, and further wherein molding the terminal portion comprises enlarging the outer diameter of the rolled over portion to a diameter greater than the remaining portion of the yarn carrier and forming a reinforced enlarged base on the yarn carrier.

3. An apparatus according to claim 2, wherein molding the terminal portion comprises enlarging the inner diameter of the rolled over portion to a diameter greater than the remaining portion of the yarn carrier and forming the reinforced enlarged base on the yarn carrier.

4. An apparatus according to claim 1, wherein said molding means comprises a plunger including a front end having a diameter less than the terminal portion of the yarn carrier and graduating to a rear end having a diameter greater than the terminal portion of the yarn carrier whereby said plunger frictionally engages the inner surface of the yarn carrier at the terminal portion as said plunger is inserted into the yarn carrier and urges the terminal portion outwardly into the recess of said die to mold the enlarged base on the yarn carrier.

5. An apparatus according to claim 4, wherein said plunger is rotatable for exerting force against the inner surface of the yarn carrier and creating friction heat facilitating the molding of the yarn carrier.

6. An apparatus according to claim 1, wherein said die comprises two arcuate die segments positioned in complimentary fashion around the outer surface proximate the terminal portion of the yarn carrier, said die segments movable in relation to the yarn carrier.

7. An apparatus according to claim 6, wherein each of said die segments are driven by an air cylinder.

8. An apparatus for forming an enlarged base on a yarn carrier comprising:
(a) a rotatable plunger for inserting into a first end of a hollow yarn carrier having walls defining an outer surface and inner surface, said plunger comprising a front end having a diameter less than the first end of the yarn carrier and graduating to a rear end having a diameter greater than the first end of the yarn carrier whereby said plunger frictionally engages the inner surface at a terminal portion of the yarn carrier;
(b) a die for being positioned around the outer surface proximate the first end of the yarn carrier, said die defining an annular recess for receiving the terminal portion of the yarn carrier therein, the recess shaped and sized to correspond to a desired shape of the enlarged base; and
(c) rotating means for rotating the yarn carrier and said rotatable plunger on a longitudinal axis whereby said plunger inserts the terminal portion of the yarn carrier into the recess of said die to mold the enlarged base on the yarn carrier.

9. An apparatus according to claim 8, wherein prior to molding the yarn carrier the terminal portion of the yarn carrier is folded inwardly on the inner surface to form a rolled over portion defining an inner diameter and an outer diameter each less than a diameter of a remaining portion of the yarn carrier, and further wherein molding the terminal portion comprises enlarging the outer diameter of the rolled over portion to a diameter greater than the remaining portion of the yarn carrier and forming a reinforced enlarged base on the yarn carrier.

10. An apparatus according to claim 8, wherein molding the terminal portion comprises enlarging the inner diameter of the rolled over portion to a diameter greater than the remaining portion of the yarn carrier and forming the reinforced enlarged base on the yarn carrier.

11. An apparatus according to claim 8, wherein said rotating means comprises a motor connected to said rotatable plunger for driving said plunger whereby said plunger rotates the yarn carrier.

12. An apparatus according to claim 8, wherein said rotating means comprises a motor connected to a rotatable mandrel for driving said mandrel, said mandrel for inserting into a second end of the yarn carrier whereby said mandrel rotates the yarn carrier and said plunger.

13. An apparatus according to claim 8, wherein said die comprises two arcuate die segments positioned in complimentary fashion around the outer surface proximate the first end of the yarn carrier, said die segments rotatable on an axis parallel to the longitudinal axis of the yarn carrier.

14. An apparatus according to claim 13, wherein said die segments are driven by an air cylinder and movable in relation to the yarn carrier.

15. A method for forming an enlarged base on a yarn carrier comprising the steps of:
(a) providing a paper yarn carrier defining an inner surface and an outer surface on opposite sides thereof, and at least one end of said yarn carrier folded inwardly to form a rolled over portion on the inner surface at a terminal portion of the yarn carrier;
(b) providing a chuck having a recess therein shaped to receive the terminal portion of the yarn carrier and extend the terminal portion of the yarn carrier outwardly upon rotating said chuck;
(c) positioning the terminal portion of the yarn carrier into the recess of the chuck; and
(d) rotating said chuck whereby the diameter of the terminal portion of the yarn carrier wall is extended outwardly and molded to form an enlarged base on the yarn carrier.

16. A method for making a yarn carrier according to claim 15, and further comprising the step of maintaining said yarn carrier in a stable position as said chuck rotates by frictionally engaging the yarn carrier with a clamp.

17. A method for making a yarn carrier according to claim 15, wherein the step of providing a paper yarn carrier comprises providing a frusto-conical or cylindrical paper yarn carrier defining an inner surface and an outer surface on opposite sides thereof, and at least one end of said yarn carrier folded inwardly to form a rolled over portion on the inner surface at a terminal portion of the yarn carrier.

18. A method for forming an enlarged base on a yarn carrier comprising the steps of:
(a) providing a paper yarn carrier defining an inner surface and an outer surface on opposite sides thereof, and at least one end of said yarn carrier folded inwardly to form a rolled over portion on the inner surface at a terminal portion of the yarn carrier;
(b) positioning a die against the outer surface at the terminal portion of the yarn carrier, said die defining a recess for receiving the terminal portion of the yarn carrier, the recess shaped and sized to correspond to a desired shape and diameter of the enlarged base; and
(c) positioning a molding mechanism within the yarn carrier at said terminal portion for inserting the terminal portion into the recess of said die to mold the enlarged base on the yarn carrier.

19. A method for making a yarn carrier according to claim 18, wherein the step of positioning a molding mechanism within the yarn carrier comprises inserting a plunger comprising a front end having a diameter less than the terminal portion of the yarn carrier and graduating to a rear end having a diameter greater than the terminal portion of the yarn carrier whereby said plunger frictionally engages the inner surface at the terminal portion and urges the terminal portion outwardly into the recess of said die to form the enlarged base on the yarn carrier.

20. A method for making a yarn carrier according to claim 18, wherein the step of positioning a molding mechanism within the yarn carrier comprises positioning a plunger rotating on a longitudinal axis of the yarn carrier and comprising a front end having a diameter less than the terminal portion of the yarn carrier and graduating to a rear end having a diameter greater than the terminal portion of the yarn carrier whereby said rotating plunger frictionally engages the inner surface at the terminal portion and urges the terminal portion outwardly into the recess of said die to mold the enlarged base on the yarn carrier.

21. A method for making a yarn carrier according to claim 18, further comprising the step of supporting the yarn carrier in a stable position with a clamp.

22. A method for making a yarn carrier according to claim 18, wherein the step of providing a paper yarn carrier comprises providing a frusto-conical or cylindrical paper yarn carrier defining an inner surface and an outer surface on opposite sides thereof, and at least one end of said yarn carrier folded inwardly to form a rolled over portion on the inner surface at a terminal portion of the yarn carrier.

23. A method for forming an enlarged base on a yarn carrier comprising the steps of:
(a) providing a paper yarn carrier defining an inner surface and an outer surface on opposite sides thereof, and at least one end of said yarn carrier folded inwardly to form a rolled over portion on the inner surface at a terminal portion of the yarn carrier;
(b) positioning a die against the outer surface at the terminal portion of the yarn carrier, said die defining a recess for receiving the terminal portion of said yarn carrier, the recess shaped and sized to correspond to a desired shape and diameter of the enlarged base;
(c) providing a rotatable plunger within the yarn carrier at the terminal portion, said plunger comprising a front end having a diameter less than the terminal portion of the yarn carrier and graduating to a rear end having a diameter greater than the terminal portion of the yarn carrier whereby said plunger frictionally engages the inner surface at the terminal portion as said plunger is inserted into the yarn carrier; and
(d) inserting said rotatable plunger into said yarn carrier, and rotating the yarn carrier yarn to urge the terminal portion outwardly into the recess of said die to mold the enlarged base on the yarn carrier.

24. A method according to claim 23, wherein the step of positioning a die against the outer surface at the terminal portion of the yarn carrier, comprises providing two arcuate complimentary die segments moveable in relation to the yarn carrier and pivotable on an axis parallel to a longitudinal axis of the yarn carrier, and positioning said die segments against the outer surface of the terminal portion.

25. A method according to claim 23, wherein the step of rotating the yarn carrier comprises rotating said plunger positioned within the yarn carrier.

26. A method according to claim 23, wherein the step of rotating the yarn carrier comprises positioning a rotatable mandrel within the yarn carrier at an end opposite to said plunger, and rotating said mandrel.

27. A method for making a yarn carrier according to claim 23, wherein the step of providing a paper yarn carrier comprises providing a frusto-conical or cylindrical paper yarn carrier defining an inner surface and an outer surface on opposite sides thereof, and at least one end of said carrier folded inwardly to form a rolled over portion on the inner surface at a terminal portion of the yarn carrier.

28. A yarn carrier having an enlarged base formed by a process comprising the steps of:
(a) providing a paper yarn carrier defining an inner surface and an outer surface on opposite sides thereof, and at least one end of said yarn carrier folded inwardly to form a rolled over portion on the inner surface at a terminal portion of the yarn carrier;
(b) providing a chuck having a recess therein shaped to receive the terminal portion of the yarn carrier and extend the terminal portion of the yarn carrier outwardly upon rotating said chuck;
(c) positioning the terminal portion of the yarn carrier into the recess of the chuck; and
(d) rotating said chuck whereby the diameter of the terminal portion of the yarn carrier wall is extended outwardly and molded to form an enlarged base on the yarn carrier.

29. A yarn carrier having an enlarged base formed by a process comprising the steps of:
(a) providing a paper yarn carrier defining an inner surface and an outer surface on opposite sides thereof, and at least one end of said yarn carrier folded inwardly to form a rolled over portion on the inner surface at a terminal portion of the yarn carrier;
(b) positioning a die against the outer surface at the terminal portion of the yarn carrier, said die defining a recess for receiving the terminal portion of the yarn carrier, the recess shaped and sized to correspond to a desired shape and diameter of the enlarged base; and
(c) positioning a molding mechanism within the yarn carrier at said terminal portion for inserting the terminal portion into the recess of said die to mold the enlarged base on the yarn carrier.

30. A yarn carrier having an enlarged base formed by a process comprising the steps of:
(a) providing a paper yarn carrier defining an inner surface and an outer surface on opposite sides thereof, and at least one end of said yarn carrier folded inwardly to form a rolled over portion on the inner surface at a terminal portion of the yarn carrier;
(b) positioning a die against the outer surface at the terminal portion of the yarn carrier, said die defining a recess for receiving the terminal portion of said yarn carrier, the recess shaped and sized to correspond to a desired shape and diameter of the enlarged base;
(c) providing a rotatable plunger within the yarn carrier at the terminal portion, said plunger comprising a front end having a diameter less than the terminal portion of the yarn carrier and graduating to a rear end having a diameter greater than the terminal portion of the yarn carrier whereby said plunger frictionally engages the inner surface at the terminal portion as said plunger is inserted into the yarn carrier; and
(d) inserting said rotatable plunger into said yarn carrier, and rotating the yarn carrier yarn to urge the terminal portion outwardly into the recess of said die to mold the enlarged base on the yarn carrier.
